(19) United States
(12) Patent Application Publication
(10) Pub. No.: US 2023/0182374 A1
(43) Pub. Date: Jun. 15, 2023

(54) FILM LAMINATING DEVICE

(71) Applicant: SHENZHEN BAITENGDA TRADING CO., LTD., Shenzhen (CN)

(72) Inventors: Fan Yu, Shenzhen (CN); Zhao Liu, Shenzhen (CN); Rufeng Yang, Shenzhen (CN); Furuo Lei, Shenzhen (CN)

(21) Appl. No.: 17/582,011

(22) Filed: Jan. 24, 2022

(30) Foreign Application Priority Data
Dec. 10, 2021 (CN) 202123114782.6

(51) Int. Cl. B29C 63/22; B29C 63/00

(52) U.S. Cl. CPC B29C 63/22; B29C 63/0095; B29L 2031/768

(57) ABSTRACT

A film laminating device is configured to attach a protective film on an electronic device. A top cover assembly comprising a protective film and a top cover is provided thereof, and the protective film comprises a protective layer and a release layer with a handle. A base is provided with a limit slot configured to place the electronic device, and when the top cover assembly is placed on a support table of the base, the side, deviating from the top cover, of the protective film may be in contact with the electronic device. The release layer is removed through pulling the handle, one end of the protective layer is in linear contact with a screen of the electronic device, the top cover is then bent upwards to be separated from the protective layer, the protective layer is gradually adsorbed on the screen according to its own gravity.

### CROSS REFERENCE TO RELATED APPLICATIONS

The present application claims the benefit of Chinese Patent Application No. 202123114782.6 filed on Dec. 10, 2021, the contents of which are incorporated herein by reference in their entirety.

### TECHNICAL FIELD

The present application relates to the technical field of electronic device accessories, in particular to a film laminating device.

### BACKGROUND ART

The screen of electronic devices such as a cell phone is easily scratched during use, which may further affect the display effect and aesthetics of the screen, therefore, a protective film is usually attached on the screen to protect the screen from being scratched. As a device to assist people in laminating films, the general film laminating process of the film laminating device is as follows: placing an electronic device in an accommodating slot, aligning the protective film with the screen area of the electronic device of the accommodating slot by a fixed structure, and then the protective film is laminated with the screen of the electronic device by peeling off the release film, thereby attaching the protective film to the electronic device. However, the existing film laminating devices generally have complicated structures and inconvenient operation.

### SUMMARY OF THE INVENTION

The present application provides a film laminating device and a top cover assembly of a film laminating device, to show a film laminating manner which is simple in structure, capable of saving assembly steps and simple and easy to operate.

In a first aspect, embodiments of the present application provide a film laminating device, wherein the top cover assembly includes a resilient top cover and a protective film, the protective film includes a protective layer configured to be attached to an electronic device and a release layer arranged to be in lamination with the protective layer, the protective film is detachably connected to the top cover, the release layer is attached to a side, deviating from the top cover, of the protective layer, the release layer is provided with a handle, and the top cover is provided with a first fixed part;

the base is provided with a limit slot configured to place an electronic device and a second fixed part and a limit buckle configured to fix the top cover, an upper end face of the slot wall of the limit slot is formed with a support table configured to place the top cover assembly, such that when the top cover assembly is placed on the support table, the side, deviating from the top cover, of the protective film may be in contact with the electronic device, and the second fixed part is in detachable and fixed connection with the first fixed part; and

when the top cover assembly is placed on the support table, a gap exists between the protective film and the support table, a handle is placed within the gap, the gap penetrates through at least one side of the film laminating device to form an outlet, to remove the release layer from the protective layer by means of the handle.

Further, in the length direction of the support table, the support table is provided with a first end and a second end arranged opposite to each other, the support end face of the first end for supporting the top cover is lower than the support end face of the second end, such that when the top cover assembly is placed on the support table, one end of the protective layer may be in linear contact with the electronic device.

Further, the support end face of the first end and the support end face of the second end are connected as an inclined surface; or, the support end face of the first end and the support end face of the second end are connected to form a stepped structure.

Further, the outlet is arranged at the first end, the limit buckle is arranged at the second end, the limit buckle is arranged opposite to the outlet, the opening of the limit buckle is arranged towards the film laminating space, to be clamped into the top cover and restrict movement of the top cover towards the side deviating from the outlet and in an up and down direction.

Further, the first fixed part includes at least two first fixed structures, the second fixed part includes at least two second fixed structures cooperating with the first fixed part, the second fixed structures are arranged at the first end, and the second fixed structures are respectively arranged on both sides of the outlet.

Further, the outer side of the support table is provided with a convex blocking table, to restrict movement of the top cover towards the outer side of the support table.

Further, the middle part of the top cover is provided with a mounting hole, the mounting hole is internally provided with a pasting member, and one side of the pasting member faces towards the protective film and is pasted and fixed with the protective film.

Further, the side of the pasting member facing towards the protective film is flush with the side of the top cover facing towards the protective film.

Further, the first fixed part includes a first fixed hole, the second fixed part includes a first projection cooperating with the first fixed hole, and the first projection is arranged at the first end;

and/or, the first fixed part includes a second projection, the second fixed part includes a second fixed hole cooperating with the second projection, and the second fixed hole is arranged at the first end.

In a second aspect, the present application provides a top cover assembly of a film laminating device, the top cover assembly includes a resilient top cover and a protective film, and the protective film includes a protective layer configured to be attached to an electronic device and a release layer arranged to be in lamination with the protective layer;

the middle part of the top cover is provided with a mounting hole, the mounting hole is internally provided with a pasting member, and one side of the pasting member faces towards the protective film and is pasted and fixed with the protective film; and the side of the pasting member facing towards the protective film is flush with the side of the top cover facing towards the protective film; and

the release layer is attached to a side, deviating from the top cover, of the protective layer, the release layer is provided with a handle, and the top cover is provided with a first fixed part.

The film laminating device provided in the embodiments of the present application includes a top cover assembly and a base, wherein the top cover assembly includes a top cover and a protective film, a handle is arranged on the release layer arranged to be in lamination with the protective layer in the protective film; the base is provided with a limit slot configured to place an electronic device, and an upper end face of the slot wall of the limit slot is formed with a support table configured to place the top cover assembly, thereby being beneficial for contact between the protective layer and the screen of the electronic device, and enabling the protective layer to be attached to the electronic device. The film laminating device is simple in structure, and the top cover is used in cooperation with the protective film, thereby eliminating the frequent disassembly steps in the film laminating process; and the handler on the release film can remove the release layer from the protective layer, and the operation is easy and simple.

### BRIEF DESCRIPTION OF THE DRAWINGS

FIG. 1 is a schematic diagram of assembly of a film laminating device in an embodiment of the present application;

FIG. 2 is a schematic diagram of a top cover assembly in an embodiment of the present application;

FIG. 3 is a schematic diagram of a base in an embodiment of the present application;

FIG. 4 is a schematic diagram of a top cover in an embodiment of the present application;

FIG. 5 is a schematic diagram of a side face of a top cover assembly in an embodiment of the present application;

FIG. 6 is a partially enlarged view of area A as shown in FIG. 5;

FIG. 7 is a schematic diagram of a side face of a support table and a top cover assembly in an embodiment of the present application.

### DETAILED DESCRIPTION OF THE EMBODIMENTS

The present application is further described in details below by means of specific execution modes and in combination with accompanying drawings. Wherein, similar elements in different execution modes adopt associated similar reference numerals. In the following execution modes, many details are described in order to enable the present application to be better understood. However, those skilled in the art will effortlessly recognize that some of these characteristics may be omitted in various conditions or may be replaced by other elements, materials, or methods. In some conditions, some operations related to the present application are not shown or described in the specification, thereby avoiding the core part of the present application from being overwhelmed by too much description, and it is not necessary for those skilled in the art to describe these related operations in details, and those skilled in the art can fully understand relevant operations according to the description in the specification and general technical knowledge of the art.

In addition, the features, operations, or characteristics described in the specification may be combined in any appropriate manner to form various execution modes, and the operational steps involved in each embodiment may be switched or adjusted in sequence in a manner that would be apparent to those skilled in the art. Therefore, the specification and accompanying drawings are merely intended to clearly describe a particular embodiment and are not intended to be necessarily compositional and/or sequential.

The serial numbers edited for the parts in the text, such as “first”, “second”, etc., are merely used to distinguish the described objects, and do not have any sequential or technical meaning. While if not specifically stated in the present application, the terms “connection” and “coupling” mentioned in the present application include direct and indirect connection (coupling).

As used herein, the length direction of the support table refers to the direction of the long side of an electronic device when the electronic device is placed in a limit slot;

the up and down direction refers to a direction vertical to the whole assembly plane when the top cover assembly is buckled with the base to form an assembling unit;

the length direction of the release film is a direction along a long side of the release film.

The outer side of the support table refers to the edge position around the top cover assembly when the top cover assembly is placed on the support table.

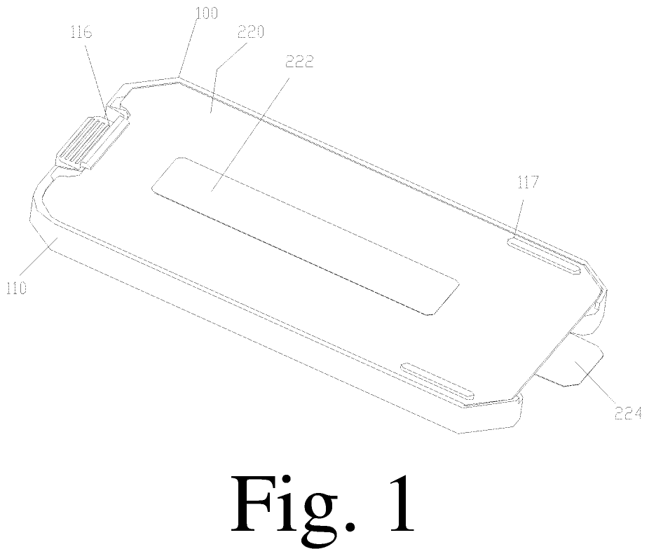

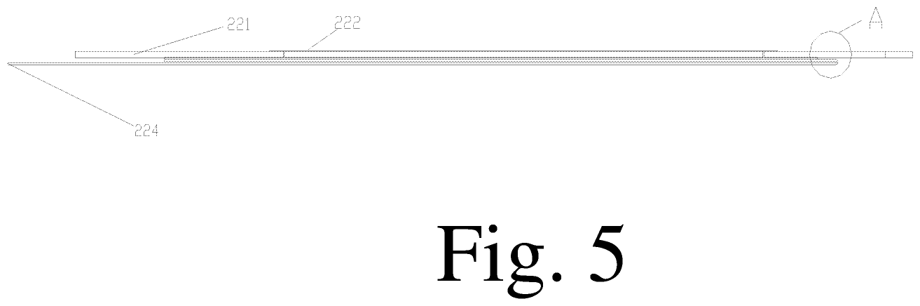

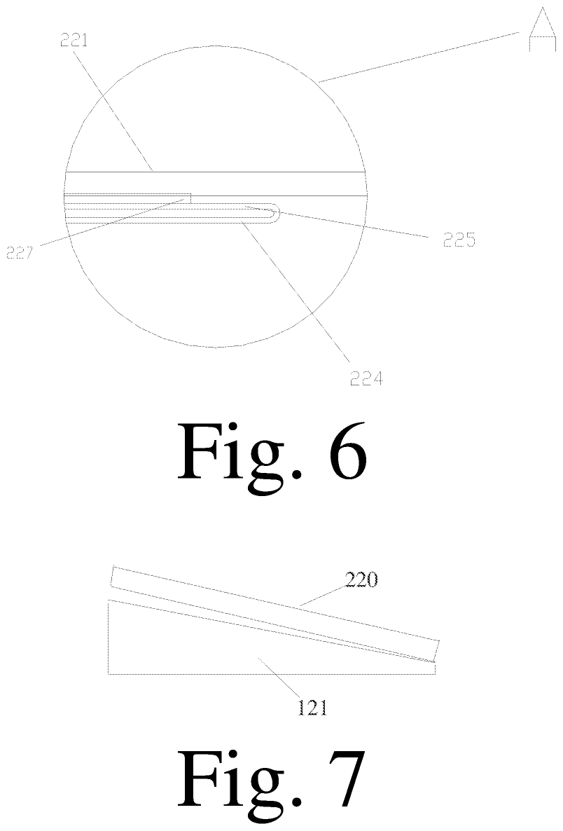

In a first aspect, the present application provides a film laminating device, in an embodiment, please refer to FIGS. 1, 2, 3, 5 and 6, the film laminating device 100 includes a base 110 and a top cover assembly 220, the top cover assembly 220 includes a resilient top cover 221 and a protective film, the protective film is detachably connected to the top cover 221, the protective film includes a protective layer 227 configured to be attached to an electronic device and a release layer 225 with a handle 224, the top cover 221 includes a first fixed part 223, and the release layer 225 is attached to the side, deviating from the top cover 221, of the protective layer 227; wherein the top cover 221 and the release layer 225 protect the protective layer 227, to prevent foreign matters from entering the protective layer 227.

In an embodiment, the top cover 221 may be a transparent material with elasticity, and may be selected from ABS, PC, PP, and PET, etc.

The base 110 is provided with a limit slot configured to place an electronic device, and a second fixed part 117 and a limit buckle 116 configured to fix the top cover assembly 220, an upper end face of the slot wall of the limit slot is formed with a support table 121 configured to place the top cover assembly 220;

please refer to FIGS. 1, 3 and 7, when the top cover assembly 220 is placed on the support table 121, a gap exists between the protective film and the support table 121, a handle is placed within the gap, the gap penetrates through at least one side of the film laminating device to form an outlet 114, to remove the release layer 225 from the protective layer 227 by means of the handle.

Further, in an embodiment, the shape of the protective layer 227 is adapted to the shape of the screen of the electronic device, at this time, the protective layer 227 can be of a rectangular diaphragm structure. The electronic device can also be a cell phone, a tablet computer or a multimedia player and some other electronic devices, which is not specifically limited herein.

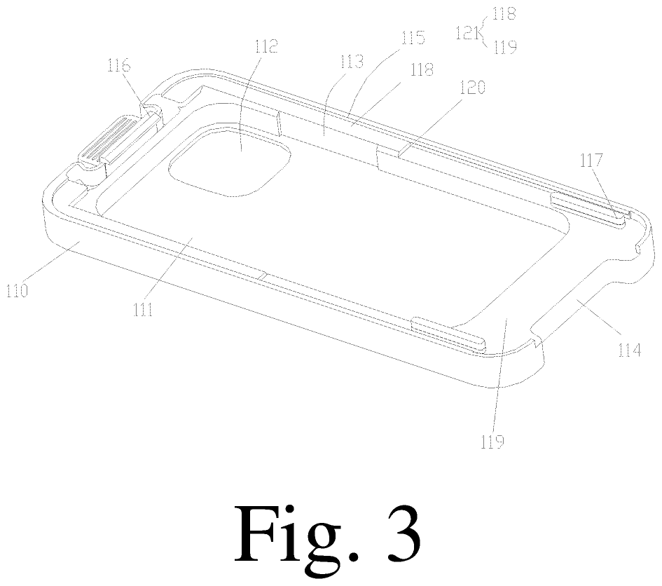

Further, in an embodiment, please refer to FIG. 3, the bottom surface of the base 110 is further provided with a camera accommodating opening 112 connecting the bottom of the slot 111 to the back of the base for accommodating a camera of the cell phone.

Further, in an embodiment, please refer to FIG. 3, one or more key slots 113 are further arranged on the slot wall of the limit slot, and the key slot 113 is configured to accommodate volume keys and power-on keys of the cell phone.

In an embodiment, please refer to FIGS. 1, 2 and 3, the handle 224 extends from one end of the release layer 225 to the other end of the release layer 225 in the length direction of the release layer, the handle 224 is longer than the release layer 225, and when the top cover assembly 220 is limited to the base 110, the handle 224 should extend to the outlet 114.

As in FIGS. 1, 2 and 6, the release layer 225 may be removed from the protective film by means of a drawstring 224 on the release layer 225, and then the top cover 221 is bent upwards and is separated from the protective layer 227, to finish film lamination. By pairing the top cover 221 with the protective film, the top cover assembly 220 is formed, thereby simplifying the film laminating device and enabling the film laminating steps to be simpler.

Further, in an embodiment, please refer to FIG. 3, in the length direction of the support table 121, the support table 121 is provided with a first end 119 and a second end 118 arranged opposite to each other, the support end face of the first end 119 for supporting the top cover 221 is lower than the support end face of the second end 118, such that when the top cover assembly 220 is placed on the support table 121, the top cover assembly 220 and the support table 121 form an inclination angle as shown in FIG. 7, to facilitate linear contact between a lower end of the protective film and the screen of the electronic device.

Further, in an embodiment, please refer to FIG. 3, the first end 119 of the support table 121 is longer than the second end 118.

Further, in an embodiment, please refer to FIG. 3, the support end face of the first end 119 may be connected with the support end face of the second end 118 through such manners including but not limited to an inclined surface or a step 120, and the inclination angle of the inclined surface and the height of the step 120 are not limited.

Further, in an embodiment, please refer to FIG. 3, the outlet 114 is arranged at the first end 119, the limit buckle 116 is arranged at the second end 118, the limit buckle 116 is arranged opposite to the outlet 114, the opening of the limit buckle 116 is arranged towards the film laminating space, to be clamped into the top cover 221 and restrict movement of the top cover 221 towards the side deviating from the outlet 114 and in an up and down direction.

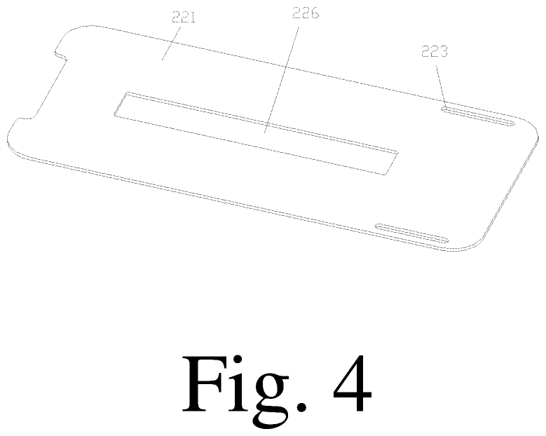

Further, in an embodiment, please refer to FIG. 3 and FIG. 4, the first fixed part 223 includes at least two first fixed structures, the second fixed part 117 includes at least two second fixed structures cooperating with the first fixed part 223, the second fixed structures are arranged at the first end 119, and the second fixed structures are respectively arranged on both sides of the outlet 114.

Further, in an embodiment, the first fixed structure includes, but is not limited to, a projection, a pit, and a buckle, and the second fixed structure correspondingly may include, but is not limited to, a pit, a projection, and a buckle, and the first fixed structure and the second fixed structure connect the top cover to the base by means of alignment fastening.

Further, in an embodiment, please refer to FIG. 3, the outer side of the support table 121 is provided with a convex blocking table 115, to restrict movement of the top cover towards the outer side of the support table 121. When the top cover assembly 220 is assembled on the base 110, the blocking table 115 is higher than or equal to the top cover 221 when viewed from the horizontal direction.

When the top cover assembly 220 is used in cooperation with the base 110 to perform film lamination on the electronic device, the blocking table 115 of the base 110, the first fixed part 223 of the top cover 221, and the second fixed part 117 of the base 110 and the limit buckle 116 may limit the top cover 221. The design is simple, and the protective film does not need to be located, thereby simplifying the structure of the device.

In an embodiment, please refer to FIG. 3 and FIG. 4, the first fixed part 223 includes a first fixed hole, the second fixed part 117 includes a first projection cooperating with the first fixed hole, and the first projection is arranged at the first end 119;

and/or, the first fixed part 223 includes a second projection, the second fixed part 117 includes a second fixed hole cooperating with the second projection, and the second fixed hole is arranged at the first end 119.

In an embodiment, the first fixed part 223 and the second fixed part 117 may also include, but are not limited to, interlocking buckles, available pins, and screw-fixation structures.

Specifically, please refer to FIGS. 1-6, when a film is laminated, an electronic device may be placed in a limit slot first, then a top cover assembly 220 is placed on the support table 121, one end of the top cover assembly 220 is placed below a limit buckle 116, the side with a protective film faces towards the electronic device, and the first fixed part 223 of the top cover assembly 220 is fastened with the second fixed part 117 of the support table 121, the limit buckle 116 is pressed at one side while the handle 224 at the outlet 114 is pulled to remove the release layer 225 from the protective layer 227, the protective layer 227 is in linear contact with the screen of the cell phone, and finally, the top cover 221 at the upper end of the outlet 114 of the first end 119 is bent upwards, such that the top cover 221 is separated from the protective layer 227, the protective layer 227 is gradually adsorbed from top to bottom according to its own gravity and is pasted on the screen of the cell phone, and film lamination may be completed with no need of manual intervention of the protective layer body.

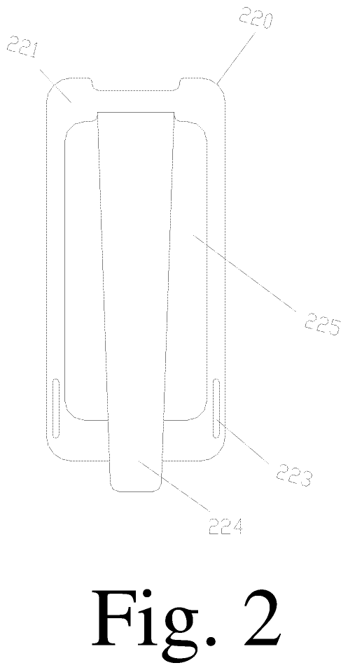

In a second aspect, the present application provides a top cover assembly of a film laminating device, in an embodiment, please refer to FIGS. 2, 4, 5 and 6, the top cover assembly 220 includes a resilient top cover 221 and a protective film which are laminated in sequence, the protective film includes a protective layer 227 and a release layer 225 with a handle 224, the protective layer and the release layer are arranged in a laminated manner, the protective layer 227 is configured to be attached to an electronic device, the release layer 225 and the top cover 221 protect the protective layer 227, to prevent such impurities as dust from entering the surface of the protective layer 227, the handle 224 is arranged on the side, deviating from the protective layer 227, of the release layer 225, and the top cover 221 is provided with a first fixed part 223.

In an embodiment, the top cover 221 may be a transparent material with elasticity, and may be selected from ABS, PC, PP, and PET, etc.

Further, in an embodiment, please refer to FIG. 1 and FIG. 4, the middle part of the top cover is provided with a mounting hole 226, the mounting hole 226 is internally provided with a pasting member 222, and one side of the pasting member 222 faces towards the protective film and the protective film is pasted and fixed on the top cover.

Further, in an embodiment, the side of the pasting member 222 facing towards the protective film is flush with the side of the top cover 221 facing towards the protective film.

Further, in an embodiment, the pasting member 222 covers or is greater than the mounting hole 226, the part not covering the mounting hole 226 is pasted with the top cover 221.

Further, in an embodiment, the shape of the mounting holes 226 includes, but is not limited to, rectangular, circular, and triangular.

Further, in an embodiment, the shape of the pasting member 222 includes, but is not limited to, rectangular, circular, and triangular.

In an embodiment, please refer to FIGS. 1 and 2, the handle 224 extends from one end of the release layer 225 to the other end of the release layer 225 in the length direction of the release layer 225, the handle 224 is longer than the release layer 225, and when the top cover assembly 220 is limited to the base 110, the handle 224 should extend to the outlet 114.

The top cover 221 may be arranged to be in lamination with and used in cooperation with the protective film, thereby saving the operational step of locating the protective film on the top cover in the film laminating process, moreover, the top cover 221 may also protect the protective film, and prevent foreign matters from entering the surface of the protective layer 221.

The present invention is described above with specific examples, and such examples are merely used to help understand the present invention, rather than limiting the present invention. For those skilled in the art of the present invention, according to the idea of the present invention, a number of simple deductions, deformations or substitutions can also be made.

What is claimed is:

1. A film laminating device, comprising:
a top cover assembly, wherein the top cover assembly comprises a resilient top cover and a protective film, the protective film comprises a protective layer configured to be attached to an electronic device and a release layer arranged to be in lamination with the protective layer, the protective film is detachably connected to the top cover, the release layer is attached to a side, deviating from the top cover, of the protective layer, the release layer is provided with a handle, and the top cover is provided with a first fixed part;
and a base, wherein the base is provided with a limit slot configured to place an electronic device and a second fixed part and a limit buckle configured to fix the top cover, an upper end face of the slot wall of the limit slot is formed with a support table configured to place the top cover assembly, such that when the top cover assembly is placed on the support table, the side, deviating from the top cover, of the protective film may be in contact with the electronic device, the second fixed part is in detachable and fixed connection with the first fixed part; and
when the top cover assembly is placed on the support table, a gap exists between the protective film and the support table, the handle is placed within the gap, the gap penetrates through at least one side of the film laminating device to form an outlet, to remove the release layer from the protective layer by means of the handle.

2. The film laminating device of claim 1, wherein in the length direction of the support table, the support table is provided with a first end and a second end arranged opposite to each other, the support end face of the first end for supporting the top cover is lower than the support end face of the second end, such that when the top cover assembly is placed on the support table, one end of the protective layer may be in linear contact with the electronic device.

3. The film laminating device of claim 2, wherein the support end face of the first end and the support end face of the second end are connected as an inclined surface;
or, the support end face of the first end and the support end face of the second end are connected to form a stepped structure.

4. The film laminating device of claim 2, wherein the outlet is arranged at the first end, the limit buckle is arranged at the second end, the limit buckle is arranged opposite to the outlet, the opening of the limit buckle is arranged towards the film laminating space, to be clamped into the top cover and restrict movement of the top cover towards the side deviating from the outlet and in an up and down direction.

5. The film laminating device of claim 4, wherein the first fixed part comprises at least two first fixed structures, the second fixed part comprises at least two second fixed structures cooperating with the first fixed part, the second fixed structures are arranged at the first end, and the second fixed structures are respectively arranged on both sides of the outlet.

6. The film laminating device of claim 3, wherein the outlet is arranged at the first end, the limit buckle is arranged at the second end, the limit buckle is arranged opposite to the outlet, the opening of the limit buckle is arranged towards the film laminating space, to be clamped into the top cover and restrict movement of the top cover towards the side deviating from the outlet and in an up and down direction.

7. The film laminating device of claim 6, wherein the first fixed part comprises at least two first fixed structures, the second fixed part comprises at least two second fixed structures cooperating with the first fixed part, the second fixed structures are arranged at the first end, and the second fixed structures are respectively arranged on both sides of the outlet.

8. The film laminating device of claim 1, wherein the outer side of the support table is provided with a convex blocking table, to restrict movement of the top cover towards the outer side of the support table.

9. The film laminating device of claim 1, wherein the middle part of the top cover is provided with a mounting hole, the mounting hole is internally provided with a pasting member, and one side of the pasting member faces towards the protective film and is pasted and fixed with the protective film.

10. The film laminating device of claim 9, wherein the side of the pasting member facing towards the protective film is flush with the side of the top cover facing towards the protective film.

11. The film laminating device of claim 1, wherein the first fixed part comprises a first fixed hole, the second fixed part comprises a first projection cooperating with the first fixed hole, and the first projection is arranged at the first end;
and/or, the first fixed part comprises a second projection, the second fixed part comprises a second fixed hole cooperating with the second projection, and the second fixed hole is arranged at the first end.
